(19) United States
(12) Patent Application Publication
(10) Pub. No.: US 2005/0001437 A1
(43) Pub. Date: Jan. 6, 2005

(54) Motor vehicle door lock

(75) Inventor: Simon Brose, Hattingen (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH and Co. KG, Wuppertal (DE)

(21) Appl. No.: 10/878,038

(22) Filed: Jun. 29, 2004

(30) Foreign Application Priority Data
Jul. 3, 2003 (DE) 103 30 194.1

(51) Int. Cl. E05C 3/06

(52) U.S. Cl. 292/216

(57) ABSTRACT

The present invention relates to a motor vehicle door lock and more specifically, to a sensor for detecting the current locking state of a motor vehicle door lock. The motor vehicle door lock of the present invention includes lock elements which further include a latch and a ratchet. The latch and the ratchet are each able to be moved into a main catch position. The latch is able to be locked in the main catch position by the ratchet. The door lock also includes a sensor for monitoring a current locking state, wherein the latch and the ratchet are coupled to the sensor such that reaching the main catch position by the latch only together with reaching the main catch position by the ratchet causes triggering of the sensor. The door lock also includes a mechanical actuating element which can be moved out of a starting position associated to the sensor, wherein both the latch and the ratchet are coupled to the actuating element to act on the actuating element.

### BACKGROUND OF THE INVENTION

1. Field of the Invention

The invention relates to a motor vehicle door lock and more specifically, to a sensor for detecting the current locking state of a motor vehicle door lock.

2. Description of Related Art

A series of possibilities are known for monitoring the current locking state in a motor vehicle door lock with conventional locking elements such as a latch and ratchet. In monitoring the state of a door lock, a problem known as “apparent locking” must be taken into consideration. Apparent locking is present when the latch is in its main catch position, but the ratchet has not engaged. In this case, the monitoring system incorrectly reports proper locking of the motor vehicle door lock.

The problem of apparent locking of a motor vehicle door lock can be eliminated using measurement engineering by scanning both the position of the latch and the position of the ratchet. However, the use of two sensors, which is necessary for this purpose, has been perceived as disadvantageous. In the known motor vehicle door lock underlying the invention, an approach which works with only one sensor has also been implemented. In such an approach, an influencing magnet is assigned to the latch and the ratchet and there is a sensor which can be influenced by a magnetic field and which can be proximity-actuated, such that the magnetic field of the influencing magnet, which field influences the sensor, reaches or exceeds a certain indicator field intensity only when the latch and the ratchet are in the main catch position.

It has been found that the construction measures which are necessary in the above explained known motor vehicle lock, especially with consideration of external influences in daily operation of a vehicle, are so complex that use of this system can be questionable in practice.

### SUMMARY OF THE INVENTION

Therefore an object of this invention is to ensure sensor monitoring of the motor vehicle door lock with high reliability and with reduced complexity.

In accordance with an exemplary embodiment of the present invention a motor vehicle door lock is disclosed. The motor vehicle door lock comprises lock elements which further include a latch and a ratchet. The latch and the ratchet are each able to be moved into a main catch position. The latch is able to be locked in the main catch position by the ratchet. The door lock also comprises a sensor for monitoring a current locking state, wherein the latch and the ratchet are coupled to the sensor such that reaching the main catch position by the latch only together with reaching the main catch position by the ratchet causes triggering of the sensor. The door lock also includes a mechanical actuating element, which can be moved out of a starting position, associated to the sensor, wherein both the latch and the ratchet are coupled to the actuating element to act on the actuating element.

Within the framework of the aforementioned monitoring, triggering of the sensor when the locking process of the motor vehicle door lock has been properly completed and both the latch and also the ratchet are in the main catch position. It should be pointed out that when the sensor is made, for example, as a microswitch either the actuation of the microswitch or the nonactuation of the microswitch can be assigned to the triggering of the sensor. This assignment follows from the construction and the special configuration of the sensor.

Implementation of mechanical coupling both of the latch and also the ratchet with the sensor by means of the provided mechanical actuating element is important. The latch and the ratchet are to a certain extent “AND” linked by this coupling, i.e. the sensor is only triggered when the latch AND the ratchet are each in its main catch position.

The mechanical implementation of the double influencing of the sensors by the latch and the ratchet which is already known from the prior art but which is implemented there with a sensor which can be actuated without contact will be made more reliable overall with consideration of the conditions of use of the motor vehicle (temperature, body vibrations, installation tolerances, etc.) with comparatively little construction effort.

There are a host of possibilities for embodying and developing this teaching of the invention. Additionally, high monitoring quality is ensured by the preferred embodiment. As long as the latch has not reached its main catch position, the ratchet is completely decoupled from the actuating element. Reaching the main catch position by the latch then to a certain extent represents the release for triggering the sensor by the engagement of the ratchet with its main catch position.

Another preferred embodiment can also be implemented. Here it is a negated “OR” linkage. If specifically the latch OR the ratchet is moved out of the respective main catch position, the sensor is moved into the untriggered state.

The invention is detailed below using drawings which show simply embodiments.

### BRIEF DESCRIPTION OF THE DRAWINGS

FIG. 1 shows a motor vehicle door lock with an arrangement for monitoring the current locking state when the latch is in a main catch position and the ratchet is in a main catch position,

FIG. 2 shows the arrangement for monitoring the current locking state as shown in FIG. 1 when the latch is in the open position and the ratchet is in the open position,

FIG. 3 shows the arrangement as shown in FIG. 2 when the latch is in the main catch position and the ratchet is in the open position,

FIG. 4 shows the arrangement as shown in FIG. 2 when the latch is in the main catch position and the ratchet is in the main catch position,

FIG. 5 shows the arrangement of another motor vehicle door lock for monitoring the current locking state when the latch is in the main catch position and the ratchet is in the main catch position,

FIG. 6 shows the arrangement as shown in FIG. 5 when the latch is in the main catch position and the ratchet is in the open position.

### DETAILED DESCRIPTION OF THE INVENTION

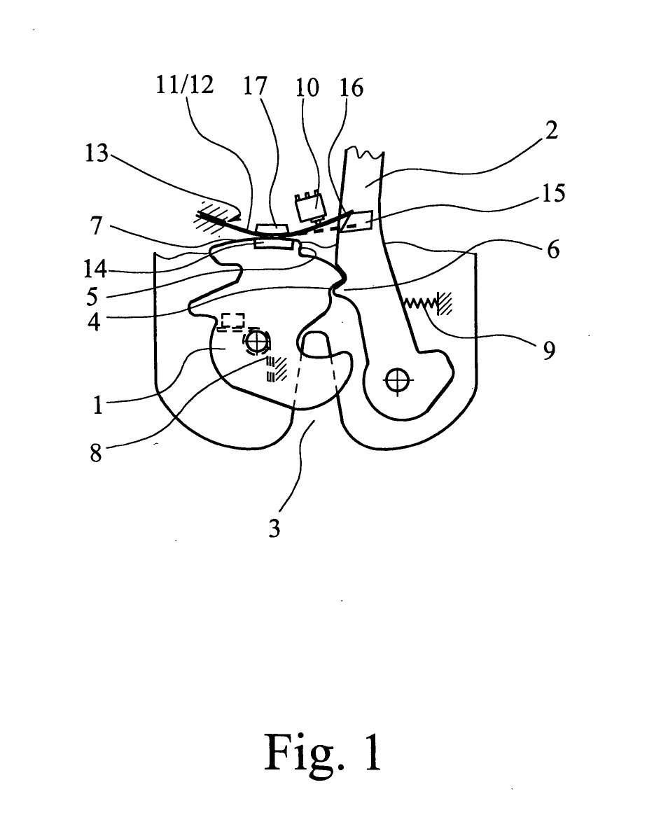

FIG. 1 shows a motor vehicle door lock with lock elements including a latch 1, a ratchet 2 and an inlet slot 3. Here, the expression motor vehicle door lock encompasses all types of door/hood or hatch locks. The latch 1 and the ratchet 2 can each be moved into a main catch position and into a preliminary catch position. For this purpose the latch 1 has a main catch 4 and a preliminary catch 5, and the ratchet 2 has a corresponding hook-shaped holding means 6. The engagement of the hook-shaped holding means 6 with the main catch 4 and with the preliminary catch 5 can lock the latch 1 in the main catch position or in the preliminary catch position. FIG. 1 shows the state in which both the latch 1 and the ratchet 2 are in the main catch position. The preliminary catch position, as described above, could be omitted, if necessary.

The latch 1, furthermore, has a contact surface 7 which keeps the ratchet 2 in its open position when the latch 1 is in the open position. The latch 1 is pretensioned via a spring element 8 into its open position, and the ratchet 2 is pretensioned via a spring element 9 into its engagement direction.

The motor vehicle door lock has a sensor 10 which can be made, in accordance with an exemplary embodiment of the present invention, as a microswitch. In FIG. 1, the sensor 10 is in a triggered state, since both the latch 1 and the ratchet 2 are in the main catch position. As is discussed in more detail below, the latch 1 and the ratchet 2 are coupled to the sensor 10 such that the movement of the latch 1 into its main catch position only together with the movement of the ratchet 2 into its main catch position causes triggering of the sensor 10. The sensor 10 is otherwise in the untriggered state. The advantages which are associated with this are described in the summary of the invention section.

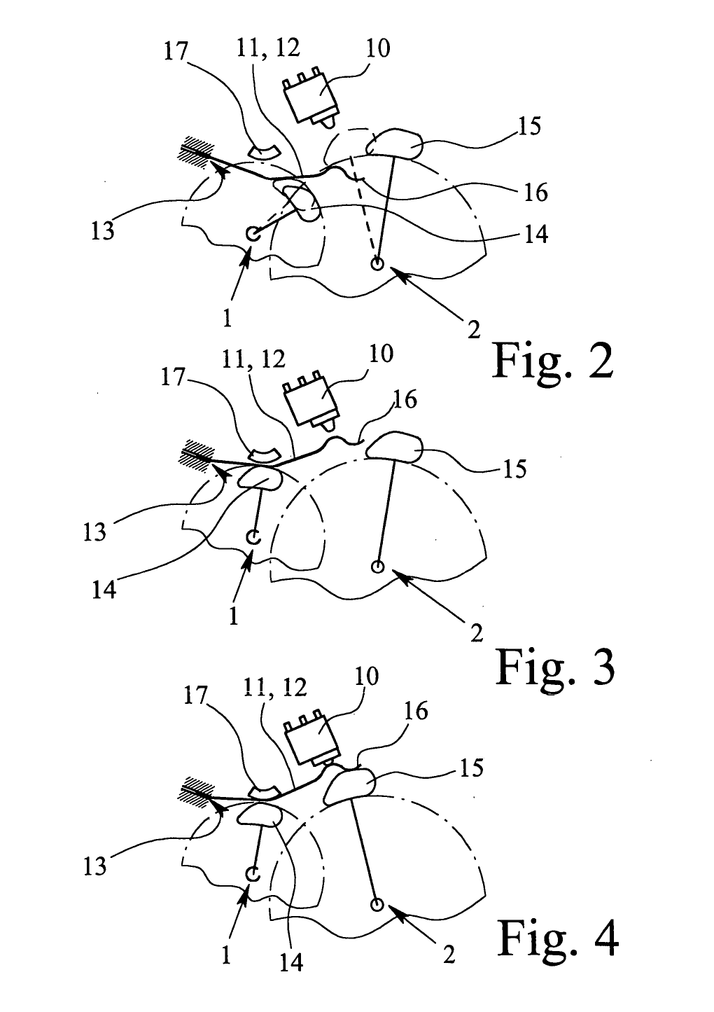

The coupling of the latch 1 and the ratchet 2 to the sensor 10 acquires special importance. The basic principle of this mechanical coupling can be seen in FIGS. 2 to 4. An adjustable mechanical actuating element 11, which can be moved out of a starting position, is assigned to the sensor 10. The starting position of the actuating element 11 is shown in FIG. 2. FIGS. 2 to 4 furthermore show that both the latch 1 and the ratchet 2 are coupled to the actuating element 11. The coupling of the latch 1 and the ratchet 2 to the sensor 10 by the adjustable mechanical actuating element 11 leads to a less fault-susceptible configuration.

In a preferred embodiment, the actuating element 11 can be elastically moved so that it automatically assumes its starting position after an adjustment. In the preferred embodiment shown in the drawings, the actuating element 11 is made as an oblong bending element 12 which is preferably clamped on one side at a clamping site 13 in the manner of a cantilever beam. Different versions are conceivable for the configuration of the bending element 12. In a preferred configuration the bending element 12 is made as a metal strip (leaf spring) or as a plastic strip, which provides economical implementations.

The basic principle of coupling between the latch 1 and the ratchet 2 to the sensor 10, in one especially preferred configuration, is that the movement of the latch 1 into its main catch position causes movement of the actuating element 11 (e.g., here the bending element 12) out of its starting position, and into the area of movement of the ratchet 2 (see FIG. 3). In this way, it is possible for the movement of the ratchet 2 into its main catch position to cause further movement of the actuating element 11 (e.g., the bending element 12) which in turn causes triggering of the sensor 10 (FIG. 4). As a result, the movement of the ratchet 2 with respect to the sensor 10 is without effect as long as the latch 1 is not in the main catch position.

The specific manner of operation in accordance with the present invention is explained below using FIGS. 2 to 4.

For coupling of the latch 1 to the actuating element 11, the latch 1 has a trip cam 14 which engages the bending element 12 when the latch 1 is moved out of the open position (shown in FIG. 2) into the main catch position (shown in FIGS. 3, 4) and causes the initial bending of the bending element 12 which is shown in FIG. 3. When the latch 1 is moved into the preliminary catch position, which is shown by the broken line in FIG. 2, the trip cam 14 does not yet engage the bending element 12, and the bending element 12 remains in the starting position shown in FIG. 2.

To couple the ratchet 2 to the actuating element 1 1, the ratchet 2 also has a trip cam 15. In the state shown in FIG. 2, the ratchet 2 is in a raised position. The preliminary catch position of the ratchet 2, which essentially coincides with the main catch position of the ratchet 2, is shown by the broken line. FIG. 2 shows that the ratchet 2 can swivel freely past the bending element 12. As long as the latch 1 is in the open position or in the preliminary catch position, the movement of the ratchet 2, as described above, has no effect on the sensor 10.

When the latch 1 is moved from the preliminary catch position which is shown in FIG. 2 by the broken line into the main catch position which is shown in FIG. 3, the ratchet 2 is first moved from the preliminary catch position shown in FIG. 2 by the broken line into the raised position which is shown in FIG. 3, in order to then drop into the main catch position shown in FIG. 4. This brief raising of the ratchet 2 makes it possible for the bending element 12 to swivel safely past the trip cam 15 of the ratchet 2. The movement of the latch 1 and the resulting first bending of the bending element 12 cause the bending element 12, with its free end 16, to move into the area of movement of the ratchet 2. The movement of the ratchet 2 into its main catch position induces a further, second bending of the bending element 12, which causes the triggering of the sensor 10.

Depending on the configuration of the actuating element 11 and of the bending element 12, it can also be provided that a part other than the free end 16 moves into the area of movement of the ratchet 2.

In the preferred embodiment shown in FIGS. 2 to 4, the aforementioned first bending of the bending element 12 takes place at the clamping site 13 of the bending element 12. By means of this first bending the bending element 12 with another point of the bending element 12 moves into the vicinity of stationary contact surface 17. The second bending of the bending element 12 which is triggered by the ratchet 2 then takes place at this other point of the bending element 12 around the contact surface 17.

In order to prevent pinching of the bending element 12 between the contact surface 17 and the trip cam 14 of the latch 1, the gap between the contact surface 17 and the trip cam 14 in the state shown in FIG. 3 can be made relatively large. Thus, the deformation of the bending element 12 in the state shown in FIG. 4 can be achieved.

In summary, the arrangement shown in FIGS. 2 to 4 provides reliable monitoring of the current locking state. In particular, apparent locking (shown in FIG. 3) does not lead to faulty triggering of the sensor 10.

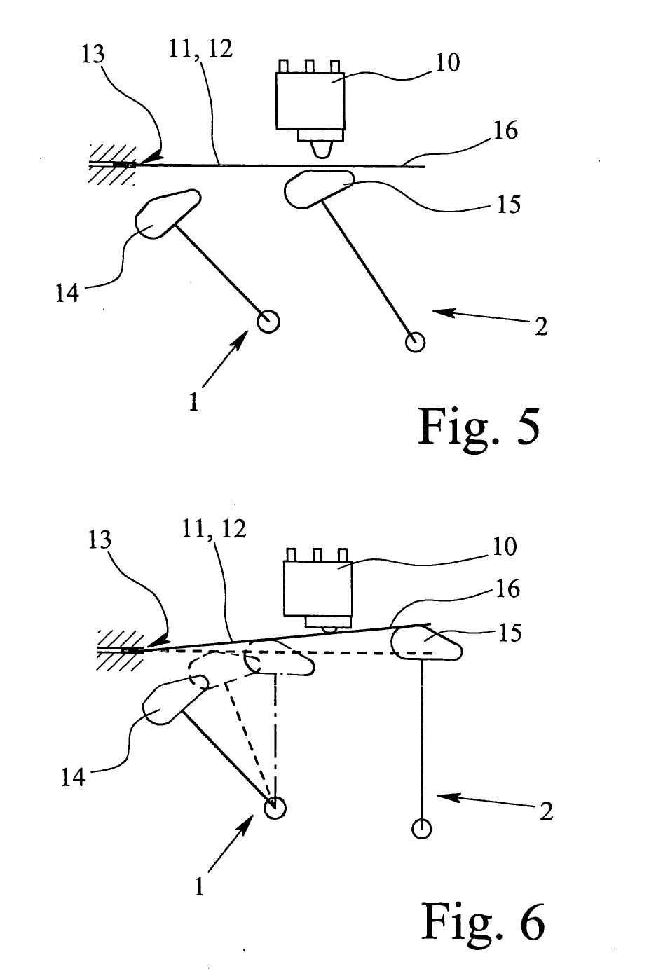

Another advantageous embodiment is shown in FIGS. 5 and 6. Here, a sensor 10, a bending element 12 which is clamped on one side, a trip cam 14 on the latch 1, and a trip cam 15 on the ratchet 2 are shown.

In the state shown in FIG. 5, the latch 1 and the ratchet 2 are each located in the main catch position. Neither the latch 1 nor the ratchet 2 are engaged with the bending element 12. Sensor 10, which can be made as a microswitch, is not actuated here by the bending element 12. FIG. 6 shows that the movement of the latch 1 from the main catch position shown in FIG. 5 into the preliminary catch position shown by the broken line in FIG. 6 and into the open position shown by the dot-dash line in FIG. 6 causes bending of the bending element 12 such that the microswitch 10 is actuated. Independently of the latch 1, the movement of the ratchet 2 from the main catch position which is shown in FIG. 5 into the open position shown in FIG. 6, likewise causes actuation of the microswitch 10 (the preliminary catch position is essentially identical here to the main catch position).

In this embodiment it is therefore such that the microswitch 10 which is in the unactuated state corresponds to the sensor 10 which is in the triggered state (FIG. 5). The “AND” linkage between the latch 1 and ratchet 2 which is shown in FIGS. 2 to 4 has therefore been converted here into a negated “OR” linkage.

In the embodiment shown in FIGS. 5 and 6 apparent closing does not lead to faulty triggering of the sensor 10 either. In this embodiment the simple and thus economical implementation is especially advantageous.

In the two above described preferred embodiments the sensor 10 has a single component, specifically a momentary-contact switch in the form of a microswitch. Basically the sensor 10 can however also have several components, for example an additional control, etc.

For the sensor 10, for example, in addition to a mechanical switch, (especially the above explained microswitch) a switch which can be actuated by proximity is also conceivable (e.g., a Hall sensor). The sensor 10 is then actuated by the mechanical actuating element which, in this case, implements the triggering action with respect to the sensor 10 without contact. It is important that the mechanical actuating element is the element which produces the coupling of influencing by the latch 1 and the ratchet.

It should furthermore be pointed out that a series of possibilities for implementing the trip cam 14 of the latch 1 and of the trip cam 15 of the ratchet 2 are conceivable. In a preferred embodiment the trip cam 14 of the latch 1 is molded on the latch 1 on the bottom or top. Accordingly the trip cam 15 of the ratchet 2 is preferably molded on the ratchet on the top or bottom.

Other advantages with respect to the ease of production and production costs arise when the bending element 12 is pressed into a slot-shaped recess in the plastic lock housing which is generally present. Similar advantages can be achieved by implementing the contact surface 17 by a corresponding configuration of the lock housing.

1. A motor vehicle door lock comprising:
lock elements including a latch and a ratchet, the latch and the ratchet each being able to be moved into a main catch position, the latch being able to be locked in the main catch position by the ratchet;
a sensor for monitoring a current locking state, wherein the latch and the ratchet are coupled to the sensor, the sensor being triggered by the latch reaching the main catch position only together with the ratchet reaching the main catch position, whereas the sensor is otherwise in the untriggered state; and
a mechanical actuating element associated with the sensor, moveable out of a starting position, wherein both the latch and the ratchet are coupled to the actuating element to act on the actuating element.

2. The motor vehicle door lock as claimed in claim 1, wherein the actuating element is an oblong bending element.

3. The motor vehicle door lock as claimed in claim 2, wherein the bending element is clamped on one end at a clamping site in the manner of a cantilever beam.

4. The motor vehicle door lock as claimed in claim 3, wherein the bending element is a metal or plastic strip.

5. The motor vehicle door lock as claimed in claim 4, wherein the movement of the latch into its main catch position causes movement of the actuating element out of its starting position, the actuating element being moveable into an area of movement of the ratchet and the ratchet then being moveable into its main catch position to cause further movement of the actuating element and triggering of the sensor.

6. The motor vehicle door lock as claimed in claim 5, wherein the movement of the latch into its main catch position causes a first bending of the bending element out of its starting position, the bending element thus being moveable into the area of movement of the ratchet and the ratchet then being moveable into its main catch position to cause a second bending of the bending element and triggering of the sensor.

7. The motor vehicle door lock as claimed in claim 6, wherein bending element is bent at the clamping site of the bending element and the bending element with another point of the bending element is moveable into the vicinity of a stationary contact surface and wherein the second bending of the bending element takes place at the other point of the bending element.

8. The motor vehicle door lock as claimed in claim 7, wherein the sensor has a momentary-contact switch.

9. The motor vehicle door lock as claimed in claim 8, wherein the switch is a microswitch.

10. The motor vehicle door lock as claimed in claim 7, wherein the sensor has a proximity sensor.

11. The motor vehicle door lock as claimed in claim 10, wherein the sensor is a Hall element.

12. The motor vehicle door lock as claimed in claim 3, wherein the movement of the latch into its main catch position causes movement of the actuating element out of its starting position, the actuating element thus being moveable into an area of movement of the ratchet and the ratchet then being moveable into its main catch position to cause further movement of the actuating element and triggering of the sensor.

13. The motor vehicle door lock as claimed in claim 12, wherein the movement of the latch into its main catch position causes a first bending of the bending element out of its starting position, the bending element thus being moveable into the area of movement of the ratchet and the ratchet then being moveable into its main catch position to cause a second bending of the bending element and triggering of the sensor.

14. The motor vehicle door lock as claimed in claim 13, wherein bending element is bent at the clamping site of the bending element and the bending element with another point of the bending element then is moveable into the vicinity of a stationary contact surface and wherein the second bending of the bending element takes place at the other point of the bending element.

15. The motor vehicle door lock as claimed in claim 14, wherein the sensor has a momentary-contact switch.

16. The motor vehicle door lock as claimed in claim 15, wherein the switch is a microswitch.

17. The motor vehicle door lock as claimed in claim 14, wherein the sensor has a proximity sensor.

18. The motor vehicle door lock as claimed in claim 17, wherein the sensor is a Hall element.

19. The motor vehicle door lock as claimed in claim 1, wherein both the movement of the latch out of its main catch position in the direction of the open position and also the movement of the ratchet out of its main catch position in the direction of a raised position cause movement of the actuating element out of its starting position and wherein only the actuating element, which is in the starting position, causes triggering of the sensor and the sensor is otherwise in the untriggered state.

20. The motor vehicle door lock as claimed in claim 19, wherein the sensor has a momentary-contact switch.

21. The motor vehicle door lock as claimed in claim 20, wherein the switch is a microswitch.

22. The motor vehicle door lock as claimed in claim 19, wherein the sensor has a proximity sensor.

23. The motor vehicle door lock as claimed in claim 22, wherein the sensor is a Hall element.

24. The motor vehicle door lock as claimed in claim 3, wherein both the movement of the latch out of its main catch position in the direction of the open position and also the movement of the ratchet out of its main catch position in the direction of a raised position cause movement of the actuating element out of its starting position and wherein only the actuating element, which is in the starting position, causes triggering of the sensor and the sensor is otherwise in the untriggered state.

25. The motor vehicle door lock as claimed in claim 24, wherein the sensor has a momentary-contact switch.

26. The motor vehicle door lock as claimed in claim 25, wherein the switch is a microswitch.

27. The motor vehicle door lock as claimed in claim 24, wherein the sensor has a proximity sensor.

28. The motor vehicle door lock as claimed in claim 27, wherein the sensor is a Hall element.
